(19) United States
(12) Patent Application Publication
(10) Pub. No.: US 2008/0068940 A1
(43) Pub. Date: Mar. 20, 2008

(54) METHOD FOR LOCKING ONTO A TRACK AFTER AN OPTICAL PICKUP OF AN OPTICAL DISC DRIVE PASSES THROUGH A DEFECTIVE SECTION OF AN OPTICAL DISC

(76) Inventors: Chang-Cheng Huang, Taipei County (TW); Chung-Hui Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/690,864

(22) Filed: Mar. 26, 2007

(30) Foreign Application Priority Data
Sep. 19, 2006 (TW) 095134606

(51) Int. Cl. G11B 7/00

(52) U.S. Cl. 369/44.32

(57) ABSTRACT

An optical disc drive generates a control signal according to the delay of a TZC signal. The control signal can determine if an optical pickup of the optical disc drive crosses a track. When the optical pickup is reading a defective section of an optical disk, the optical disc drive cannot correct the movement of the optical pickup. Therefore, after the optical pickup passes through the defective section of the optical disc, the optical disc drive adjusts the gain of the tracking drive signal according to the control signal.

### BACKGROUND OF THE INVENTION

1. Field of the Invention

The present invention relates to a method for locking a track in an optical disc drive, and more particularly, to a method for locking onto a track after an optical pickup of an optical disc drive passes through a defective section of an optical disc.

2. Description of the Prior Art

Please refer to FIG. 1. FIG. 1 is a block diagram of an optical disc drive 10 according to the prior art. The optical disc drive 10 comprises an optical pickup 12, a spindle motor 14, a motor controller 16, a focus controller 18, a tracking controller 20, a microprocessor 22, a servo system 24, and a signal converter 26. The optical pickup 12 outputs a laser beam Li with a predetermined power and a predetermined wavelength to an optical disc 11. The optical disc 11 has a spiral track 28. The track 28 has eight-to-fourteen modulation (EFM) data represented by a plurality of lands and pits. When the laser beam Li contacts the lands and pits, the lands and the pits reflect the laser beam Li so as to generate a laser beam Lr. The optical pickup 12 generates a corresponding analog signal EFMa according to the laser beam Lr. Then, the signal converter 26 converts the analog signal EFMa to a digital signal EFMd. Finally, the microprocessor 22 can process the digital EFMd to obtain the storage data D.

When the optical disc 11 is placed in the optical disc drive 10, the microcontroller 22 drives the motor controller 16 to adjust a rotation rate of the spindle motor 14, and drives the servo system 24 to adjust movement of the optical pickup 12. When the laser beam Li cannot focus on the track 28 or deviates from the track 28, the analog signal EFMa generated by the optical pickup 12 has errors. Thus, the optical pickup 12 generates a focus error signal FE and a tracking error signal TE according to the reflected laser beam Lr. The focus controller 18 outputs a focus driving signal FOO to the servo system 24 according to the focus error signal FE. The tracking controller 20 outputs a tracking driving signal TRO to the servo system 24 according to the tracking error signal TE. The servo system 24 can adjust the distance between the optical pickup 12 and the optical disc 11 according to the focus driving signal FOO, and adjust the movement of the optical pickup 12 parallel to the optical disc 11 according to the tracking driving signal TRO.

When the optical disc 11 is scraped or damaged, forming a defect, the defective section of the optical disc 11 and the good area of the optical disc reflect the laser beam Lr differently. The optical disc drive 10 has a defect detection system for identifying the defective section of the optical disc 11 by the difference of the reflected laser beam Lr reflected from different areas. A method for identifying a defective section of the optical disc 11 according to the prior art compares the intensity of the laser beam Lr reflected from the optical disc 11 instantaneously with an average intensity of all reflected laser beams Lr reflected over a predetermined period. When the difference is greater than a predetermined value, the optical disc drive 10 generates a defect signal showing that the optical pickup 12 is reading a defective section. While the optical pickup 12 is reading the defective section, the servo system 24 cannot correct the movement of the optical pickup 12 according to the focus error signal FE and the tracking error signal TE, so the optical pickup 12 continues moving in the original direction through the defective section. The optical pickup 12 may deviate the original track after passing through the defective section. Thus, if the servo system 24 corrects the movement of the optical pickup 12 according to the focus error signal FE and the tracking error signal TE, the optical pickup 12 may lock onto the wrong track.

### SUMMARY OF THE INVENTION

According to an embodiment of the present invention, a method for locking a track after an optical pickup of an optical disc drive passes through a defective section of an optical disc comprising generating a control signal according to a delay of a tracking zero crossing (TZC) signal generated by the optical disc drive; and adjusting a gain of a tracking drive signal generated by the optical disc drive according to the control signal when a tracking error (TE) signal generated by the optical disc drive shows that the optical pickup of the optical disc drive enters a trackable section from an untrackable section.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an optical disc drive according to the prior art.

FIG. 2 is a diagram of an optical disc having a defective section.

FIG. 3 is a diagram of waveforms of control signals according to the present invention.

FIG. 4 is a diagram of waveforms of the method for locking onto a track according to the present invention.

FIG. 5 is a flowchart of the method for locking onto the track according to the present invention.

### DETAILED DESCRIPTION

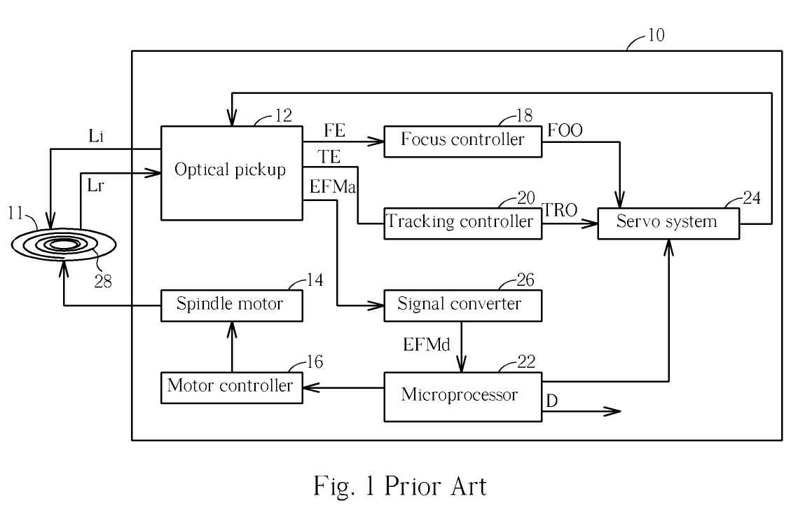

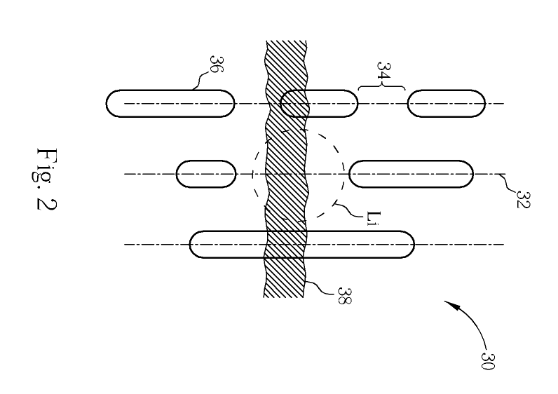

Please refer to FIG. 1 and FIG. 2. FIG. 2 is a diagram of an optical disc 30 having a defective section 38. The embodiment according to the present invention utilizes the optical disc drive 10 in FIG. 1 to read the optical disc 30 having the defective section 38. The optical disc 30 comprises a plurality of tracks 32. The plurality of tracks 32 represent data with a plurality of lands 34 and pits 36 of different length. The optical pickup 12 outputs a laser beam Li with a predetermined power to the optical disc 30. When the laser beam Li contacts the lands 34 and pits 36, the lands 34 and the pits 36 reflect the laser beam Li differently so that the optical pickup 12 can generate electrical signals corresponding to the reflected laser beams, and the microprocessor 22 can read the data of the optical disc 30. In addition, the optical pickup 12 generates a focus error signal FE and a tracking error signal TE according to the reflected laser beams, so that the optical disc drive 10 can correct the movement of the optical pickup 12 and determine if the optical pickup 12 is passing through the defective section 38. However, when the optical pickup 12 is passing through the defective section 38, the optical disc drive 10 cannot correct the movement of the optical pickup 12. After the optical pickup 12 passes through the defective section 38, the optical disc drive 10 adjusts the optical pickup 12 to the correct track 32 according to the focus error signal FE and the tracking error signal TE.

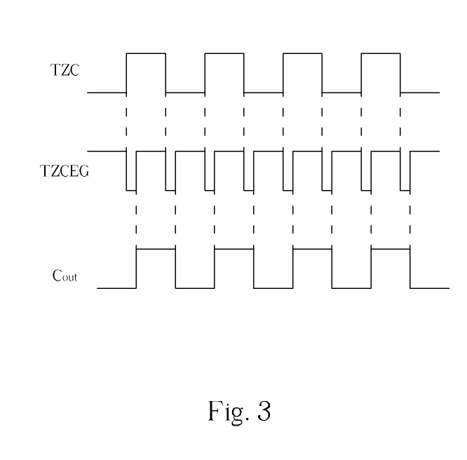

Please refer to FIG. 1 and FIG. 3. FIG. 3 is a diagram of waveforms of control signals according to the present invention. When the optical disc drive 10 reads the optical disc 30, the optical disc drive 10 generates a tracking zero crossing (TZC) signal for controlling the movement of tracking and crossing of the optical pickup 12. In addition, the optical disc drive 10 generates a TZC delay signal TZCEG according to the rising edge and falling edge of one delayed pulse of the TZC signal, and generates a control signal Cout according to the TZC delay signal TZCEG. The control signal Cout is used in a pre-amplifier of the optical disc drive 10 and indicates the status of the optical pickup 12 crossing the track 32. When the optical pickup 12 is passing through the defective section 38 of the optical disc 30, the optical disc drive 10 cannot correct the movement of the optical pickup 12 according to the tracking error signal TE, so the optical pickup 12 keeps moving in the original direction on the defective section 38. Thus, the optical pickup 12 may deviate from the original track 32 after passing through the defective section 38. Accordingly, the optical disc drive 10 generates the control signal Cout when reading the optical disc 30, so the optical disc drive 10 can determine if the optical pickup 12 deviates from the original track 32 after the optical pickup 12 passes through the defective section 38 according to the control signal Cout, so as to adjust the tracking driving signal TRO of the optical disc drive 10. Thus, the optical disc drive 10 can control movement of the optical pickup 12 along the original track 32 of the optical disc 30 and read the data of the optical disc 30.

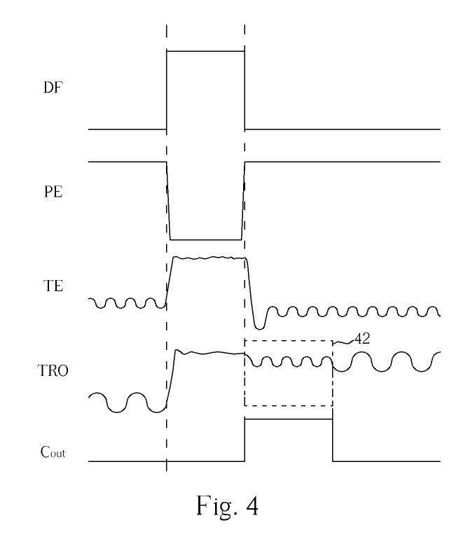

Please refer to FIG. 1 and FIG. 4. FIG. 4 is a diagram of waveforms of the method for locking onto a track according to the present invention. A defect detection system of the optical disc drive 10 generates a defect signal DF that indicates that the optical pickup 12 is passing through a defective section 38. A main beam sum signal PE represents a summation of the output laser beam Li and the reflected laser beam Lr of the optical pickup 12. The optical disc drive 10 utilizes the tracking driving signal TRO to control the horizontal movement of the optical pickup 12. The tracking error signal TE represents the error of the horizontal movement of the optical pickup 12. The defect signal DF rises to a high level when the optical disc drive 10 is reading the defective section 38 of the optical disc 30. During the period when the level of the defect signal DF is high, the optical pickup 12 cannot receive the reflected laser beam precisely. Thus, the main beam sum signal PE and the tracking error signal TE are at a low level, which the optical disc drive 10 cannot read, so the optical disc drive 10 cannot correct the movement of the optical pickup 12 according to the tracking error signal TE, so that the optical pickup 12 keeps moving in the original direction through the defective section. After the optical pickup 12 passes through the defective section 38, the optical disc drive 10 can correct the movement of the optical pickup 12 according to the tracking error signal TE. However, the optical pickup 12 may deviate from the original track 32 at this time. In the method for the optical disc drive 10 to lock onto the track according to the present invention, after the optical pickup 12 passes through the defective section 38, the optical disc drive 10 opens a control window 42 to monitor the control signal Cout. When the level of the control signal Cout is high in the control window 42, the optical pickup 12 may deviate from the original track. Thus, the optical disc drive 10 adjusts the tracking driving signal TRO in the control window 42, increasing or decreasing the gain of the tracking driving signal TRO, for example. In the meanwhile, the optical disc drive 10 corrects the movement of the optical pickup 12 according to the tracking error signal TE, so that the optical pickup 12 can remain on the original track.

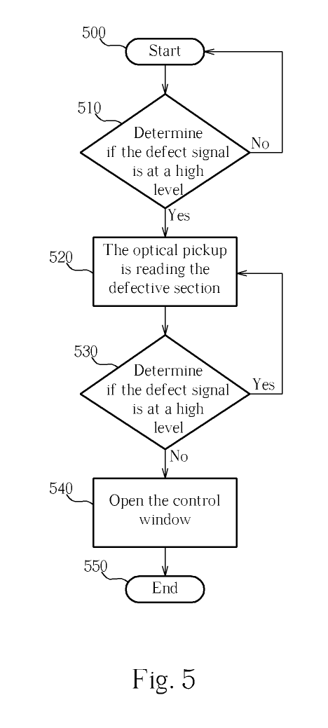

Please refer to FIG. 5. FIG. 5 is a flowchart of the method for locking onto the track according to the present invention. The steps of the method for locking onto the track are as follows.

Step 500: Start. The optical pickup 12 of optical disc drive 10 outputs the laser beam Li while moving along a track 32 of the optical disc 30, so that the optical disc drive 10 can read the data of the optical disc 30 recorded by lands 34 and pits 36. Moreover, the optical disc drive 10 generates a control signal Cout according to the TZC delay signal TZCEG, which indicates the status of the optical pickup 12 as it crosses the track 32.

Step 510: Determine if the level of the defect signal DF is high; if yes, go to Step 520; if no, go back to Step 500;

Step 520: When the level of the defect signal DF is high, the optical disc drive 10 determines that the optical pickup 12 is passing through the defective section 38 resulted from a scrape or damage. Thus, the optical disc drive 10 cannot determine the main beam sum signal PE and the tracking error signal TE, so the optical disc drive 10 cannot correct the movement of the optical pickup 12 according to the tracking error signal TE and the optical pickup 12 moving along the original direction.

Step 530: Determine if the defect signal DF is still at a high level; if yes, go to Step 520; if no, go to Step 540;

Step 540: The optical pickup 12 is passing through the defective section 38, so the optical disc drive 10 has to lock onto the track 32 again, so as to read correct data. The optical disc drive 10 opens a control window 42 to monitor the control signal Cout, so as to adjust the tracking driving signal TRO. The optical disc drive 10 can increase or decrease the gain of the tracking driving signal TRO according to the control signal Cout, and correct the movement of the optical pickup 12 according to the tracking error signal TE, so that the optical pickup 12 can remain on the original track.

Step 550: End.

In summary, when the optical disc drive according to the present invention reads the optical disc, the optical disc drive generates the control signal according to the delay of the TZC signal. The control signal can determine if the optical pickup of the optical disc drive crosses the track. Moreover, the optical disc drive generates the defect signal to show that the optical pickup is passing through the defective section of the optical disc. However, the optical disc drive can correct the movement of the optical pickup according to the tracking error signal until the optical pickup passes through the defective section, at which time the optical pickup may deviate from the original track. Thus, the present invention provides a method for locking onto a track after an optical pickup of an optical disc drive passes through a defective section of an optical disc. After the optical pickup passes through the defective section of the optical disc, the optical disc drive opens the control window to adjust the gain of the tracking drive signal according to the control signal. So, the situation of the optical pickup locking the wrong track after passing through the defective section can be improved.

Those skilled in the art will readily observe that numerous modifications and alterations of the device and method may be made while retaining the teachings of the invention.

What is claimed is:

1. A method for locking a track after an optical pickup of an optical disc drive passes through a defective section of an optical disc comprising:
generating a control signal according to a delay of a tracking zero crossing (TZC) signal generated by the optical disc drive; and
adjusting a gain of a tracking drive signal generated by the optical disc drive according to the control signal when a tracking error (TE) signal generated by the optical disc drive shows that the optical pickup of the optical disc drive enters a trackable section from an untrackable section.

2. The method of claim 1, wherein generating the control signal according to the delay of the TZC signal generated by the optical disc drive comprises:
generating a TZC delay signal according to a pulse delay period of rising edges and falling edges of the TZC signal generated by the optical disc drive; and
generating the control signal according to the TZC delay signal.

3. The method of claim 1, wherein adjusting the gain of the tracking drive signal generated by the optical disc drive according to the control signal when the TE signal generated by the optical disc drive shows the optical pickup of the optical disc drive enters the trackable section from the untrackable section is adjusting the gain of the tracking drive signal generated by the optical disc drive if the control signal is high when the TE signal generated by the optical disc drive represents the optical pickup of the optical disc drive enters the trackable section from the untrackable section.

4. The method of claim 1, wherein adjusting the gain of the tracking drive signal generated by the optical disc drive according to the control signal is decreasing or increasing the gain of the tracking drive signal generated by the optical disc drive according to the control signal.

5. The method of claim 1 further comprising:
determining if the optical pickup of the optical disc drive is locked onto the track according to the TE signal generated by the optical disc drive.

6. The method of claim 1 further comprising:
generating a defect signal when the optical pickup of the optical disc drive passes through the defective section of the optical disc.

7. The method of claim 1 further comprising:
determining if the optical pickup of the optical disc drive shifts tracks according to the control signal.
